(19) United States
(12) Patent Application Publication
(10) Pub. No.: US 2024/0020381 A1
(43) Pub. Date: Jan. 18, 2024

(54) SECURITY MACHINE LEARNING STREAMING INFRASTRUCTURE IN A VIRTUALIZED COMPUTING SYSTEM

(71) Applicant: VMware, Inc., Palo Alto, CA (US)

(72) Inventors: Alexander Julian THOMAS, Brooklyn, NY (US); Taruj GOYAL, Mountain View, CA (US); Xiaosheng WU, Mountain View, CA (US); Deepak Chowdary METTEM, Mountain House, CA (US); Anjali MANGAL, Cupertino, CA (US); Amit CHOPRA, Cedar Park, TX (US)

(21) Appl. No.: 17/867,478

(22) Filed: Jul. 18, 2022

(51) Int. Cl. G06F 21/55; G06F 21/53

(52) U.S. Cl. CPC G06F 21/552; G06F 21/53; G06F 2221/031

(57) ABSTRACT

An example method of classifying alerts generated by endpoints in a virtualized computing system includes: receiving, at an alert processing engine executing in the virtualized computing system, a stream of the alerts generated by security agents executing in the endpoints; extracting fields from the alerts at the alert processing engine; computing, at the alert processing engine, features from the alerts based on the fields; computing, at the alert processing engine, a plurality of model scores for each alert using the features as parametric input to a plurality of models; aggregating, by the alert processing engine, the plurality of model scores into a final score for each alert; and annotating each of the alerts with a respective final score.

Applications today are deployed onto a combination of virtual machines (VMs), containers, application services, physical servers without virtualization, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A user, or automated software on behalf of an Infrastructure as a Service (IaaS), interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

A virtualized computing system can include an endpoint security platform for securing endpoints (e.g., VMs). An endpoint security platform can include security agents deployed in each endpoint (e.g., VM) that perform various security actions, such as antivirus/antimalware actions, device assessment and remediation actions, and the like. The security agents can be controlled by and managed through a backend security service. The security agents across all VMs and hosts in the data center can generate a large stream of alerts (e.g., hundreds of thousands or millions of alerts) to be processed by the security platform. Users desire real-time classification of alerts to reduce alert fatigue and show valid sets of alerts as opposed to false positives that would be difficult if not impossible to be reviewed by the user due to the amount of data. Such real-time classification requires a scalable solution for handling the large stream of alerts.

### SUMMARY

In embodiments, a method of classifying alerts generated by endpoints in a virtualized computing system is described. The method includes receiving, at an alert processing engine executing in the virtualized computing system, a stream of the alerts generated by security agents executing in the endpoints; extracting fields from the alerts at the alert processing engine; computing, at the alert processing engine, features from the alerts based on the fields; computing, at the alert processing engine, a plurality of model scores for each alert using the features as parametric input to a plurality of models; aggregating, by the alert processing engine, the plurality of model scores into a final score for each alert; and annotating each of the alerts with a respective final score.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a virtualized computing system in which embodiments described herein may be implemented.

FIG. 2 is a block diagram depicting an alert processing engine according to embodiments.

FIG. 3 is a flow diagram depicting a method of classifying alerts by an alert processing engine according to embodiments.

### DETAILED DESCRIPTION

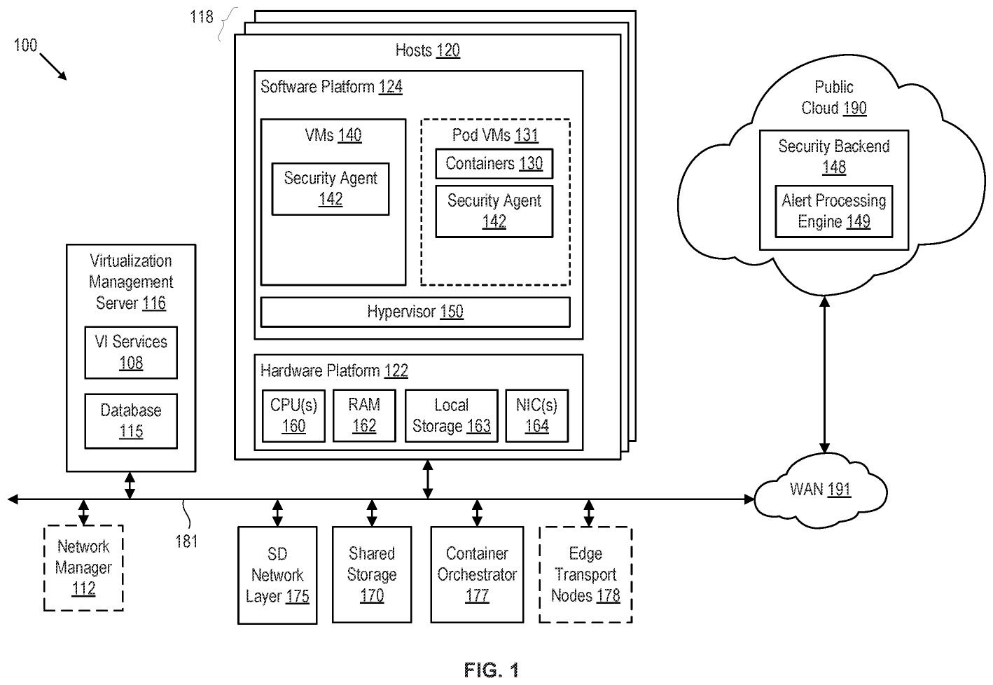

FIG. 1 is a block diagram of a virtualized computing system 100 in which embodiments described herein may be implemented. Virtualized computing system 100 can be a multi-cloud system having a private data center in communication with a public cloud 190. In embodiments, the private data center can be controlled and administered by a particular enterprise or business organization, while public cloud 190 is operated by a cloud computing service provider and exposed as a server available to account holders (“tenants”). The operator of the private data center can be a tenant of public cloud 190 along with a multitude of other tenants. The private data center is also known variously as an on-premises data center, on-premises cloud, or private cloud. The multi-cloud system is also known as a hybrid cloud system. In embodiments, virtualized computing system can be a single-cloud system, where the techniques described herein are performed in one cloud system (e.g., private data center or public cloud 190). Public cloud 190 can include infrastructure similar to that described below for the private data center.

The private data center is a software-defined data center (SDDC) that includes hosts 120. Hosts 120 may be constructed on server-grade hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 181. Physical network 181 enables communication between hosts 120 and between other components and hosts 120 (other components discussed further herein).

In the embodiment illustrated in FIG. 1, hosts 120 access shared storage 170 by using NICs 164 to connect to network 181. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN (vSAN), which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a. “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

Virtualized computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to a wide area network (WAN) 191 (e.g., a corporate network, the public Internet, etc.). Edge transport nodes 178 can include a gateway (e.g., implemented by a router) between the internal logical networking of host cluster 118 and the external network. The private data center can interface with public cloud 190 through edge transport nodes 178 and WAN 191. Edge transport nodes 178 can be physical servers or VMs. Virtualized computing system 100 also includes physical network devices (e.g., physical routers/switches) as part of physical network 181, which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host Cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118. While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VMware NSX® platform made commercially available by VMware, Inc. of Palo Alto, CA. In other embodiments, SD network layer 175 is orchestrated and managed by virtualization management server 116 without the presence of network manager 112.

Virtual ration management server 116 can include various virtual infrastructure (VI) services 108. VI services 108 can include various services, such as a management daemon, distributed resource scheduler (DRS), high-availability (HA) service, single sign-on (550) service, and the like. VI services 108 persist data in a database 115, which stores an inventory of objects, such as clusters, hosts, VMs, resource pools, datastores, and the like. Users interact with VI services 108 through user interfaces, application programming interfaces (APIs), and the like to issue commands, such as forming a host cluster 118, configuring resource pools, define resource allocation policies, configure storage and networking, and the like.

In embodiments, services can also execute in containers 130. In embodiments, hypervisor 150 can support containers 130 executing directly thereon. In other embodiments, containers 130 are deployed in VMs 140 or in specialized VMs referred to as “pod VMs 131.” A pod VM 131 is a VM that includes a kernel and container engine that supports execution of containers, as well as an agent (referred to as a pod VM agent) that cooperates with a controller executing in hypervisor 150. In embodiments, virtualized computing system 100 can include a container orchestrator 177. Container orchestrator 177 implements an orchestration control plane, such as Kubernetes®, to deploy and manage applications or services thereof in pods on hosts 120 using containers 130. Container orchestrator 177 can include one or more master servers configured to command and configure controllers in hypervisors 150. Master server(s) can be physical computers attached to network 181 or implemented by VMs 140/131 in a host cluster 118.

In embodiments, the virtual computing instances (e.g., VMs 140 and pod VMs 131) each include a security agent 142 and a utility 144. Security agent 142 is configured to cooperate with a security backend 148 to perform various security functions, such as virus/malware detection and prevention, software auditing and remediation, and the like. Security backend 148 includes an alert processing engine 149 to process a stream of alerts generated by security agents 142 in the virtual computing instances.

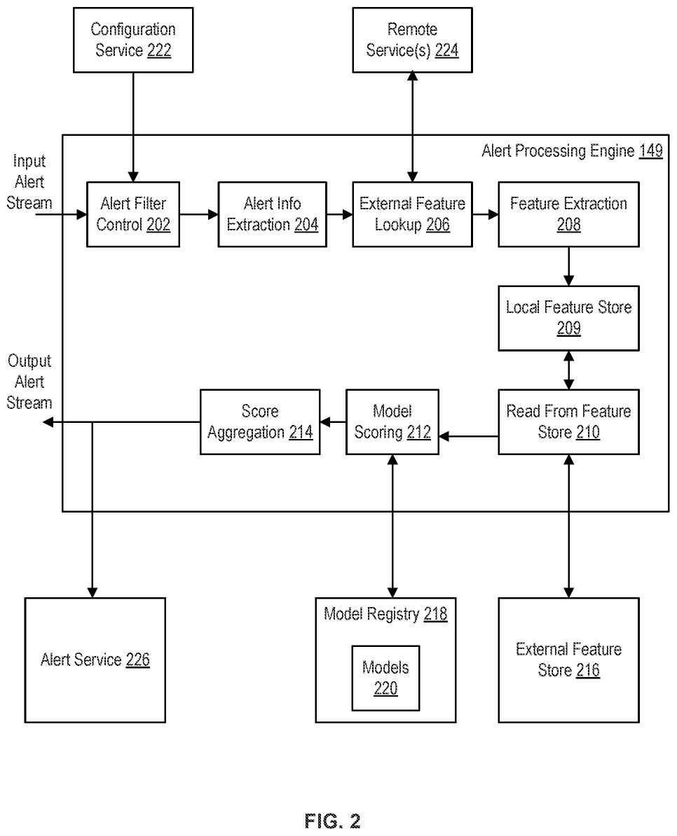

FIG. 2 is a block diagram depicting alert processing engine 149 according to embodiments. Alert processing engine 149 receives an input alert stream. The input alert stream comprises alerts generated by security agents 142, which send the alerts to security backend 148. Alert processing engine includes an alert filter control function 202, an alert information extraction function 204, an external feature lookup function 206, a feature extraction function 208, a location feature store 209, a read from feature store function 210, a model scoring function 212, and a score aggregation function 214. Alert processing engine 149 interacts with external entities, including a configuration service 222, remote service(s) 224, a model registry 218, and an external feature store. These external entities can be part of security backend 148 or external to security backend 148.

Alert filter control function 202 receives the input alert stream. Alert filter control function 202 also receives configurations from configuration service 222. Alert filter control function 202 passes the alert stream on to alert information extraction function 204. Alert information extraction function 204 passes the alert stream on to external feature lookup function 206. External feature lookup function 206 passes the alert stream on to feature extraction function 208. Feature extraction function 208 is configured to store information in local feature store 209 and passes the alert stream on to model scoring function 212, Read from feature store function 210 is configured to read information from local feature store 209 and provide such information to model scoring function 212. Model scoring function 212 passes the alert stream on to score aggregation function 214. Score aggregation function 214 provides an output alert stream of alert processing engine 149. In embodiments, model scoring 212 can interact with model register 218. In embodiments, read from feature store function 210 can interact with external feature store 216,

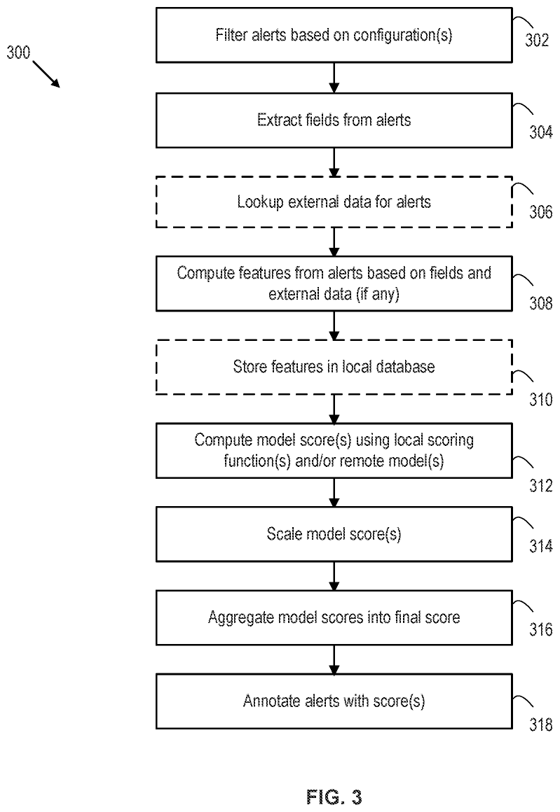

FIG. 3 is a flow diagram depicting a method 300 of classifying alerts by alert processing engine 149 according to embodiments. Method 300 begins at step 302, where alert filter control function 202 filters the alerts based on one or more configurations provided by configuration service 222. In embodiments, the pipeline of alert processing engine 149 only processes specific alerts based on some criteria set forth in configuration(s). User(s) can create configuration(s) to ensure that specific alerts are processed. Unless otherwise indicated, alerts not eligible for classification are not processed by subsequent stages of the pipeline. Filtering alerts based on configurations provided by configuration service 222 provides for zero-downtime or near zero-downtime, real-time dynamic updates of business configuration to be applied to alert processing engine 149. Alert processing engine 149 can efficiently handle constant configuration changes ranging from updating of machine learning models to enablement of different rules for different users. These changes can occur in real-time and alert processing engine 149 can be updated accordingly. This minimizes downtime caused by disruption from restarts.

At step 304, alert information extraction function 204 extracts fields from alerts selected by alert filter control function 202 to be processed. An alert can include a plurality of fields each having a value. The fields can indicate any of a myriad of information, such as the source of the alert (e.g., organization, host, VM, etc.), the activity the generated the alert, and the like. The extracted fields are used for feature computation, as discussed below.

At step 306, in some embodiments, external feature lookup function 206 performs a lookup of external data for alert(s) from remote service(s) 224. For example, external feature lookup function 206 can make an inference to a remote hosted model, external service, external database, or the like to return data that is required for feature computation and lookup by subsequent functions of the pipeline. In embodiments, external feature lookup function 206 also performs local computation(s) on alerts, such as command line normalizations.

At step 308, feature extraction function 208 computes features from alerts based on the extracted fields and external data (if any). In general, a feature is an individual measurable property or characteristic of an alert. Features can be numeric (e.g., a feature vector), strings, graphs, or the like. The features computed by feature extraction function 208 can depend on the particular model(s) in use by model scoring function 212. That is, a particular model can require a certain set of features. Thus, depending on the required features for the model(s) in use, feature extraction function 208 can be configured to compute such features from the extracted alert fields and external information (if any).

In embodiments, at step 310, computed features can be stored in local feature store 209. Whether features are stored in local feature store 209 can depend on the model(s) in use. In embodiments, local feature store 209 is stateful. For example, features computed from alerts generated by a source (e.g., a VM) can be stored over some window of time (e.g., some number of hours) in association with such source. Some computed features can be stored in local feature store 209, While other features may not be stored. For example, a model in use may require a set of data for an input feature to be obtained over a time period (e.g., the state of an input feature over time). Other models in use may require only an instantaneous value for an input feature (e.g., instantaneous feature state).

At step 312, model scoring function 212 uses computed features to generate score(s) for model(s). For example, model scoring function 212 can generate scores for a plurality of models concurrently. In embodiments, a model can be a local scoring function of model scoring function 212. In other embodiments, a model can be hosted remotely in model registry 218 (e.g., one of a plurality of models 220 in model registry 218). Model scoring function 212 can receive features directly from feature extraction function 208. For stateful features, model scoring function 212 can use read from feature store function 210 to obtain such stateful features from local feature store 209 or from external feature store 216. In embodiments, external feature store 216 can store stateful features computed over a longer period of time as compared to local feature store 209 (e.g., 24 hours) and computed periodically for a batches of alerts (e.g., every 24 hours). Since local database 209 can use a smaller window and updates feature state based on the most recently computed features, local database 209 can store more relevant information for sources than external feature store 216 (e.g., the state of a source now versus the state of the source yesterday). In embodiments, model scoring function 212 also achieves deduplication through batching of requests to model registry 218. Configurable batching windows can reduce network backpressure, and costs by grouping and optimizing similar operations and optimizing similar operations by minimizing cross-service interaction through amortization over the window. Furthermore, alert processing engine 149 can scale to support any number of machine learning models (e.g., models 220 in model registry 218). Additional models 220 can be added over time and alert processing engine 149 can be configured to extract features for use with such models.

In embodiments, at step 314, the scores computed by model scoring function 212 are scaled. Scaling ensures that different models that penalize anomalies are normalized to ensure fairness during aggregation. At step 316, score aggregation function 214 aggregates model scores into a final score (potentially scaled model scores). At step 318, score aggregation function 214 annotates each alert with a final score. In some embodiments, alerts can be annotated with individual non-aggregated model scores (by either score aggregation function 214 or model scoring function 212).

Alert processing engine 149 can provide the output alert stream to an alert service 226 for further processing. Alert service 226 can analyze model scores annotated on the alerts and perform different actions depending on the model scores. For example, alert service 226 can notify a user if a final model score for an alert exceeds a threshold final model score A user can configured alert service 226 to generate notifications as desired based on model scores that annotate the alerts.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of classifying alerts generated by endpoints in a virtualized computing system, comprising:
receiving, at an alert processing engine executing in the virtualized computing system, a stream of the alerts generated by security agents executing in the endpoints;
extracting fields from the alerts at the alert processing engine;
computing, at the alert processing engine, features from the alerts based on the fields;
computing, at the alert processing engine, a plurality of model scores for each alert using the features as parametric input to a plurality of models;
aggregating, by the alert processing engine, the plurality of model scores into a final score for each alert; and
annotating each of the alerts with a respective final score.

2. The method of claim 1, further comprising:
filtering, at the alert processing engine, the stream of alerts based on at least one configuration.

3. The method of claim 1, further comprising:
obtaining, by the alert processing engine, external data associated with the alerts;
wherein the features are computed based on the fields and the external data.

4. The method of claim 1, wherein the alert processing engine includes a local database, and wherein the method further comprises:
storing, by the alert processing engine, the features in the local database over a period of time in association with the endpoints.

5. The method of claim 4, wherein the features input to the plurality of models include stateful features obtained from the local database.

6. The method of claim 1, further comprising:
obtaining, by the alert processing engine, stateful features from an external database;
wherein the features input to the plurality of models include the stateful features obtained from the external database.

7. The method of claim 1, further comprising:
scaling, by the alert processing engine, the plurality of model scores prior to the step of aggregating.

8. A non-transitory computer readable medium comprising instructions to be executed in a computing device to cause the computing device to carry out a method of classifying alerts generated by endpoints in a virtualized computing system, comprising:
receiving, at an alert processing engine executing in the virtualized computing system, a stream of the alerts generated by security agents executing in the endpoints;
extracting fields from the alerts at the alert processing engine;
computing, at the alert processing engine, features from the alerts based on the fields;
computing, at the alert processing engine, a plurality of model scores for each alert using the features as parametric input to a plurality of models;
aggregating, by the alert processing engine, the plurality of model scores into a final score for each alert; and
annotating each of the alerts with a respective final score.

9. The non-transitory computer readable medium of claim 8, further comprising:
filtering, at the alert processing engine, the stream of alerts based on at least one configuration.

10. The non-transitory computer readable medium of claim 8, further comprising:
obtaining, by the alert processing engine, external data associated with the alerts;
wherein the features are computed based on the fields and the external data.

11. The non-transitory computer readable medium of claim 8, wherein the alert processing engine includes a local database, and wherein the method further comprises:
storing, by the alert processing engine, the features in the local database over a period of time in association with the endpoints.

12. The non-transitory computer readable medium of claim 11, wherein the features input to the plurality of models include stateful features obtained from the local database.

13. The non-transitory computer readable medium of claim 8, further comprising:
obtaining, by the alert processing engine, stateful features from an external database;
wherein the features input to the plurality of models include the stateful features obtained from the external database.

14. The non-transitory computer readable medium of claim 8, further comprising:
scaling, by the alert processing engine, the plurality of model scores prior to the step of aggregating.

15. A virtualized computing system, comprising:
a plurality of hosts executing virtual machines (VMs), the VMs executing security agents; and
a cloud executing a security backend in communication with the security agents, the security backing including an alert processing engine configured to:
receive a stream of the alerts generated by security agents executing in the endpoints;
extract fields from the alerts;
compute features from the alerts based on the fields;
compute a plurality of model scores for each alert using the features as parametric input to a plurality of models;
aggregate the plurality of model scores into a final score for each alert; and
annotate each of the alerts with a respective final score.

16. The virtualized computing system of claim 15, wherein the alert processing engine is configured to:
filter the stream of alerts based on at least one configuration.

17. The virtualized computing system of claim 15, wherein the alert processing engine is configured to:
obtain external data associated with the alerts;
wherein the features are computed based on the fields and the external data.

18. The virtualized computing system of claim 15, wherein the alert processing engine includes a local database, and wherein the alert processing engine is configured to:
store the features in the local database over a period of time in association with the endpoints.

19. The virtualized computing system of claim 18, wherein the features input to the plurality of models include stateful features obtained from the local database.

20. The virtualized computing system of claim 15, wherein the alert processing engine is configured to:
obtain stateful features from an external database;
wherein the features input to the plurality of models include the stateful features obtained from the external database.
